(19) United States
(12) Patent Application Publication
(10) Pub. No.: US 2007/0122232 A1
(43) Pub. Date: May 31, 2007

(54) Ball joint assembly

(76) Inventors: Tomasz Buchner, Sterling Heights, MI (US); Swaminathan Krishnan, Sterling Heights, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/287,828

(22) Filed: Nov. 28, 2005

(51) Int. Cl. F16C 11/00

(52) U.S. Cl. 403/122

(57) ABSTRACT

The invention contemplates a ball and joint assembly having a ball portion and at least one shank portion with an end. The end of the shank portion mounts within a mounting recess in a washer. Adhesive may be applied between the end of the shank and the mounting recess to enhance the retention of the washer on the shank portion. This ball joint may be employed in a vehicle suspension.

### BACKGROUND OF INVENTION

The present invention relates generally to ball joint assemblies.

FIG. 1 illustrates a prior art ball joint assembly 10, also called a ball and socket joint. This ball joint assembly 10 includes a stud 12 having a ball portion 14 between a pair of shank portions 16. The ball portion 14 engages a bearing 18 of a socket 20. A socket shell 22 surrounds and supports the bearing 18. Grease seals 24 engage each end of the socket shell 22 and shank portions 16 to define a grease cavity 26. Annular retaining rings 36 and annular washers 38 provide biasing forces to the grease seals 24 to assure that an adequate seal is maintained.

In this ball joint assembly 10, a central bore 28 extends through the ball portion 14 and the shank portions 16. The central bore 28 includes washer mounting counter-bores 30 at either end. A pair of washers 32 each include a mounting lip 34 that mounts into its corresponding mounting counter-bore 30 and is secured therein by an interference fit. In order to assure an adequate interference fit, the stud 12 and washers 32 must be machined to tight tolerances at the locations where the interference fit occurs. This tight tolerance machining is more expensive than is desirable for fabricating and assembling the ball joint assembly 10. Moreover, the stud 12 and washers 32 require a certain minimum hardness in order to account for the high contact stresses at the locations of the interference fit. Again, the cost is more than is desirable.

### SUMMARY OF INVENTION

According to an aspect of the invention, there is provided a ball joint assembly including a stud having a ball portion adjacent to a shank portion and a central bore extending through the stud, with the shank portion having an end. The ball and joint assembly also includes a bearing mounted about the ball portion, a shell mounted about and securing the bearing to the ball portion, and a washer having a central hole concentric with the central bore and a mounting recess mounted about the end of the shank portion.

According to another aspect of the invention, there is provided a ball joint assembly for use with a vehicle suspension. The ball and joint assembly may include a stud having a ball portion between a first and a second shank portion, with the first shank portion having a first end and the second shank portion having a second end; and a central bore, extending through the stud and adapted to receive a rod therethrough for operative engagement with vehicle frame flanges. The ball and joint assembly may also include a bearing mounted about the ball portion; a shell mounted about and securing the bearing to the ball portion, with the shell being adapted to operatively engage a suspension link; a first washer having a first central hole concentric with the central bore and a first mounting recess mounted about the first end of the first shank portion; and a second washer having a second central hole concentric with the central bore and a second mounting recess mounted about the second end of the second shank portion.

According to another aspect of the invention, there is provided a ball joint assembly including a stud having a ball portion adjacent to a shank portion and a central bore extending through the stud, with the shank portion having an end and the ball portion adapted to operatively engage a bearing. The ball and joint assembly may also include a washer having a central hole concentric with the central bore and a mounting recess mounted about the end of the shank portion, and an adhesive between the end of the shank portion and the mounting recess of the washer.

The present invention advantageously provides a ball joint assembly having washers adequately mounted and retained on a stud, while—contrary to the prior art—not requiring an interference fit or generating high contact stresses. This allows for the use of a lower hardness material and avoids the need to machine tight tolerance features where the washers mount to the stud.

Another advantage of an embodiment of the present invention is that the washers, since they do not require machining to tight tolerances, can be cold formed, without requiring post forming machining operations.

### BRIEF DESCRIPTION OF THE DRAWINGS

FIG. 1 is a cross section of a prior art ball joint assembly.

FIG. 2 is a cross section of a ball joint assembly according to the present invention.

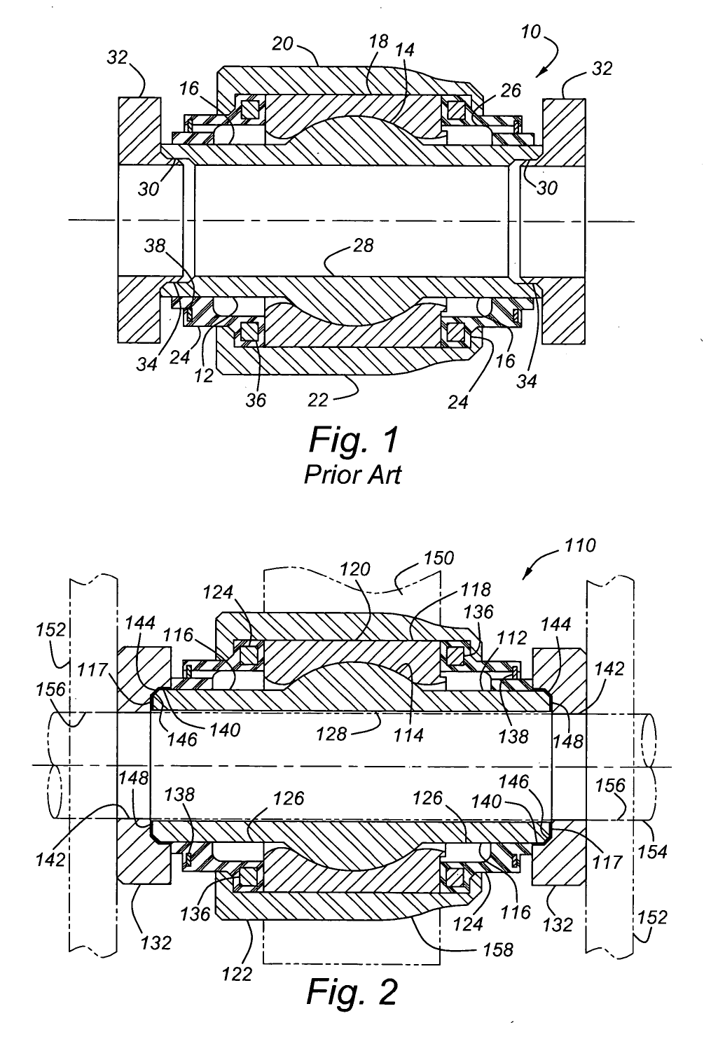

### DETAILED DESCRIPTION

Referring to FIG. 2, a ball joint assembly, indicated generally at 110, is shown. The ball joint 110 may be used in various applications, such as, for example, to secure a suspension link 150 to flanges 152 of a vehicle frame while allowing relative rotation and pivotal movement between the link 150 and flanges 152.

The ball joint assembly 110 includes a stud 112 having a ball portion 114 between a pair of shank portions 116. The stud 112 may be made of steel, although other suitable materials may be employed if so desired. A central bore 128 extends through the stud 112. A rod 154 with threaded end portions (not shown), for example, may extend through the central bore 128 and engage holes 156 in the vehicle frame flanges 152. A pair of nuts (not shown) may thread onto the threaded end portions to secure the rod 154 to the flanges 152.

The ball portion 114 of the stud 112 engages a bearing 118. The bearing 118 may be made of a plastic, such as nylon, or some other suitable material. The bearing 118 mounts in and is supported by a socket 120 of a socket shell 122. The socket shell 122 may be made of steel, although other suitable materials may be employed, if so desired. The suspension link 150 may include a passage 158 within which the socket shell 122 is secured.

A pair of grease seals 124 each engage a respective end of the socket shell 122 and corresponding shank portions 116 to define a pair of grease cavities 126. Annular retaining rings 136 and annular washers 138—or, alternatively ring springs—bias the grease seals 124 into contact with the socket shell 122 and shank portions 116. The grease seals 124 may be made of rubber or some other suitable elastomeric material. The purpose of the seals 124 is to prevent lubricant (such as grease) from leaking from the ball joint assembly 110 and also to prevent contaminants from entering.

A pair of washers 132 each mount between a respective one of the ends 117 of the shank portions 116 and a corresponding one of the vehicle frame flanges 152. The washers 132 may be made of steel, although other suitable materials may be employed if so desired. Each washer 132 includes central holes 142 that are axially aligned with the central bore 128 in the stud 112 in order to receive the rod 154 therethrough.

Each washer 132 also includes a mounting recess 140 that mounts about the end of its respective shank portion 116. The fit between the mounting recesses 140 and their respective shank portions 116 may be transition-to-slight interference. Adhesive 148 is applied between the contact areas of the washers 132 and shank portions 116 to enhance retention of the washers 132 on the shank portions 116. The shank portions 116 may include chamfers 144 about their outer corners that mate with corresponding features 146 in the mounting recesses 140 of the washers 132.

Since an interference fit is not required, the shaft portions 116 and washers 132 do not need to be machined to tight tolerances, thus reducing the overall cost of the ball joint assembly 110. Moreover, the area of contact between the stud 112 and washers 132 is relatively large, and, in addition, without the need for an interference fit at these locations, the minimum hardness required for the material of the ball stud 112 and washers 132 can be relatively less than otherwise might be required. Again, this allows for a reduced overall cost of the ball joint assembly 110.

While certain embodiments of the present invention have been described in detail, those familiar with the art to which this invention relates will recognize various alternative designs and embodiments for practicing the invention as defined by the following claims.

What is claimed is:

1. A ball joint assembly comprising:
a stud having a ball portion adjacent to a shank portion and a central bore extending through the stud, with the shank portion having an end;
a bearing mounted about the ball portion;
a shell mounted about and securing the bearing to the ball portion; and
a washer having a central hole concentric with the central bore and a mounting recess mounted about the end of the shank portion.

2. The ball joint assembly of claim 1 further including an adhesive between the end of the shank portion and the mounting recess of the washer.

3. The ball joint assembly of claim 2 wherein the stud includes a second shank portion in opposed relation to the shank portion and having a second end in opposed relation to the end, and the ball joint assembly further includes a second washer having a second central hole concentric with the central bore and a second mounting recess mounted about the second end of the second shank portion.

4. The ball joint assembly of claim 3 further including an adhesive between the second end of the second shank portion and the second mounting recess of the second washer.

5. The ball joint assembly of claim 3 wherein the end has a chamfer thereon and the washer recess includes a feature mating with the chamfer.

6. The ball joint assembly of claim 2 wherein the end has a chamfer thereon and the washer recess includes a feature mating with the chamfer.

7. The ball joint assembly of claim 1 wherein the end has a chamfer thereon and the washer recess includes a feature mating with the chamfer.

8. The ball joint assembly of claim 1 wherein the stud includes a second shank portion in opposed relation to the shank portion and having a second end in opposed relation to the end, and the ball joint assembly further includes a second washer having a second central hole concentric with the central bore and a second mounting recess mounted about the second end of the second shank portion.

9. The ball joint assembly of claim 1 further including a grease boot extending between and in sealing engagement with the shell and the shank portion.

10. A ball joint assembly for use with a vehicle suspension comprising:
a stud having a ball portion between a first shank portion and a second shank portion, with the first shank portion having a first end and the second shank portion having a second end; and a central bore, extending through the stud and adapted to receive a rod therethrough for operative engagement with vehicle frame flanges;
a bearing mounted about the ball portion;
a shell mounted about and securing the bearing to the ball portion, with the shell being adapted to operatively engage a suspension link;
a first washer having a first central hole concentric with the central bore and a first mounting recess mounted about the first end of the first shank portion; and
a second washer having a second central hole concentric with the central bore and a second mounting recess mounted about the second end of the second shank portion.

11. The ball joint assembly of claim 10 further including an adhesive between the first end of the first shank portion and the first mounting recess of the first washer.

12. The ball joint assembly of claim 11 further including an adhesive between the second end of the second shank portion and the second mounting recess of the second washer.

13. The ball joint assembly of claim 12 wherein the first end and the second end each have a chamfer thereon, and the first washer recess includes a first feature mating with the chamfer of the first end and the second washer recess includes a second feature mating with the chamfer of the second end.

14. The ball joint assembly of claim 11 wherein the first end has a chamfer thereon and the first washer recess includes a feature mating with the chamfer.

15. The ball joint assembly of claim 10 further including a first grease boot extending between and in sealing engagement with the shell and the first shank portion.

16. The ball joint assembly of claim 15 further including a second grease boot extending between and in sealing engagement with the shell and the second shank portion.

17. The ball joint assembly of claim 10 wherein the first and second washers are each adapted to be sandwiched between the respective first and second ends and a respective one of the vehicle frame flanges.

18. A ball joint assembly comprising:
a stud having a ball portion adjacent to a shank portion and a central bore extending through the stud, with the shank portion having an end and the ball portion adapted to operatively engage a bearing;
a washer having a central hole concentric with the central bore and a mounting recess mounted about the end of the shank portion; and
an adhesive between the end of the shank portion and the mounting recess of the washer.

19. The ball joint assembly of claim 18 wherein the end has a chamfer thereon and the washer recess includes a feature mating with the chamfer.

20. The ball joint assembly of claim 18 wherein the stud includes a second shank portion in opposed relation to the shank portion and having a second end in opposed relation to the end, and the ball joint assembly further includes a second washer having a second central hole concentric with the central bore and a second mounting recess mounted about the second end of the second shank portion.
